(19) United States
(12) Patent Application Publication
(10) Pub. No.: US 2020/0030814 A1
(43) Pub. Date: Jan. 30, 2020

(54) METHOD AND DEVICE FOR WASHING/CLEANING GRANULAR MATERIAL FROM SLAG AND WASHING/CLEANING BOTTOM/BOILER ASH FROM THERMAL WASTE TREATMENT

(71) Applicants: TARTECH ECO INDUSTRIES AG, Berlin (DE); H-U-R HAMBURG GMBH HAMBER-UMWELT-RECYCLINGTECHNOLOGIEN, Hamburg (DE)

(72) Inventor: Claus Gronholz, Ahausen/Eversen (DE)

(21) Appl. No.: 16/481,456

(22) PCT Filed: Jan. 24, 2018
(86) PCT No.: PCT/EP2018/051755

§ 371 Date: Oct. 9, 2019

(30) Foreign Application Priority Data
Jan. 27, 2017 (DE) 10 2017 101 657.0

(51) Int. Cl. B03B 9/04; C22B 7/00; C22B 7/04; B07B 1/22

(52) U.S. Cl. CPC B03B 9/04; C22B 7/006; B09B 3/0083; B07B 1/22; C22B 7/04

(57) ABSTRACT

The invention relates to a method for removing salt deposits on slag granular material. According to the invention, the MSWI slag granular material is introduced into a liquid bath which is subjected to ultrasound, and the slag granular material is moved in the liquid bath.

The invention relates to a method for washing/cleaning granular material from slag and washing/cleaning bottom/boiler ash from thermal waste treatment. In particular, the invention relates to the cleaning of slag from municipal solid waste incinerators, so-called MSWI slags, or waste incineration plants. Furthermore, the invention relates to a device for removing salt deposits on slag granular material. In particular, salts such as chlorides and sulfates are to be dissolved and removed, which are located in the pores and fissured surfaces of the granules and cannot or only inadequately be removed by conventional washing methods. The granular material can have any grain size. In particular, however, a granular material with the grain size 1/32 mm is to be freed of the salt deposits. Slag granular material or granular material are discussed in the following, without any restriction being attached thereto.

In the thermal treatment of household waste, large quantities of bottom and boiler ash arise as residue, which must be disposed of. In addition to minerals, this bottom/boiler ash also contain metals, stone or glass, other non-combustible or incombustible residues as well as pollutants that do not permit and make possible simple landfilling. Another use of bottom/boiler ash, for example, as fillers or building materials in the construction industry is not readily or not possible because of the pollutants contained therein. Nevertheless, a use of the treated bottom/boiler ash referred to here as slag would be desirable as filler or foundation or substructure material in the construction industry, because in this way the slag can be used economically. Landfilling and the removal of the otherwise required raw materials such as gravel, natural stone and sand for such use can thereby be dispensed with.

For a granular material to be used as a building material, for example in road construction, it must comply with specified limit values with regard to certain pollutants. These are specified for Germany in the Technical Rules of the Working Group of Federal States on Waste in Soil [German: Länderarbeitsgemeinschaft Abfall (TR-LAGA Boden)]. Depending on the pollutant content, the slags are divided into certain classification values Z0, Z1, Z2, Z3 and higher. Slags with a classification value Z0 can be used in any way. The classification value Z1 allows use as a building material without further technical auxiliary equipment. In the case of the classification value of Z1, a distinction is made between the value Z1.1 and Z1.2 in the case of the TR-LAGA Soil. With a classification value of Z2, sealing measures must be taken to prevent leaching of pollutants from the slag and thereby contamination of the soil or groundwater. For the construction industry, slag granular material with a classification value Z1 is therefore of great importance.

Metals can be removed from the crushed slag relatively well with known measures. The surface structure of the individual slag grains, which is open-pored and rugged, presents problems, however. Salts and in particular chlorides and sulfates are preferably deposited in these pores, which thus cannot be removed by simple washing processes. Chlorides and sulphates, however, are contained in the slag from domestic waste incineration plants in relatively large quantities which are far above the limit values for the classification value Z1 or Z2 of the TR-LAGA. However, this also results even in case of compliance with the limit values for other pollutants to a classification number greater than Z2, so that unrestricted utilization as a building material is no longer possible.

Thus, the limit value of TR-LAGA (version as of November 2003) for chloride for the classification value Z1.1 is 20 mg/I, and 40 mg/l for the classification value Z1.2 and 150 mg/l for the classification value Z2. The limit value for sulphate is 150 mg/l for the classification value Z1.1, 300 mg/I for the classification value Z1.2 and 600 mg/l for the classification value Z2. When the eluate determination for the slag from typical household waste incineration plants without treatment is performed, the measured values for chloride are of the order of 590 mg/l and for sulfate 640 mg/l, i.e. well above the limit values. The quantity stated here refers to the eluate according to DIN EN ISO 10304-1/-2 D19/20.

By conventional washing of the slag granular material, these eluate levels can be lowered to about 130 mg/l for chloride and about 320 mg/I for sulfate. But even these values do not allow a classification into the classification value Z 1.

The invention has set the task of providing a method and device for washing/cleaning slag granular material with which the adhering salts can be easily removed. In particular, the chloride and sulfate contents are thereby lowered so that the classification value Z1 is complied with according to the TR-LAGA.

To achieve the object, it is proposed according to the invention that the MSWI slag granular material are introduced into a liquid bath, which is exposed to ultrasound, and that the MSWI slag granular material is moved in the liquid bath. In particular, the MSWI slag granular material can be circulated at least once. It has surprisingly been found that by treating the MSWI slag granular material with ultrasound, a significant reduction of the sulfate and chloride content in the eluate could be affected. Thus, the chloride content dropped to 36 mg/l and the sulfate content to 96 mg/l. This allowed compliance with the limit values for the classification value Z1.

It is favorable when the slag granular material is introduced into a treatment basket which is immersed in the liquid bath and when the treatment basket moves in the liquid bath. This makes it possible to charge the liquid bath with the slag granular material by simple means. In particular, it is provided that the walls of the treatment basket are designed as a sieve sized according to the granulation, which allow the salts to escape into the liquid bath. Also, a sieve does not interfere with the action of ultrasound on the granular material.

Furthermore, the granular material remains safely in the treatment basket during its movement. Elaborate emptying and cleaning of the liquid bath is eliminated. As a liquid, water can be used, which can absorb the escaping salts well.

The container can be filled intermittently with the MSWI slag granular material and emptied again. Such a batch operation allows good treatment of the MSWI slag granular material in the liquid bath for a predetermined period of time. The duration of treatment can be between 30 sec and 360 sec and in particular between 60 sec and 120 sec. The actual treatment time also depends on the ultrasound power applied.

It is expedient that the slag granular material is pre-cleaned prior to the application of ultrasound in order to remove suspended matter, light materials and adhesive grains. These substances would otherwise interfere with the action of the ultrasound on the granular material.

It is particularly expedient if the slag granular material is cleaned after the application/treatment with ultrasound in order to remove the salts expelled or dissolved from the slag granular material. Then, the salts that have leaked from the pores but are still adhering to the surface of the granular material are safely removed, so that a further reduction of the salt content can be achieved. Thus, the chloride content of the initially investigated and treated MSWI slag after the final purification was only 27 mg/l and the sulfate content was only 94 mg/l.

Accordingly, this three-stage washing/cleaning method means that the salt content of slag from municipal solid waste incineration plants can be brought well below the limit values applicable to the classification value Z1. A technical utilization of this purified slag in construction is therefore possible without further structural sealing measures.

It is furthermore advantageous if the liquid bath contains a heated liquid and/or can be heated. The temperature can be, for example, 40° C. and can be held at this value. This improves the effect of the ultrasound on the granular material and the leaching of the salts from the pores of the granular material. Above all, the duration of treatment can be reduced.

The ultrasound application can take place at a frequency of 20 kHz to 50 kHz and in particular from 25 kHz to 40 kHz, simultaneously. Such oscillating systems with operating frequencies of 25 kHz or 40 kHz are known and available for example as immersible transducers also for higher powers. Therefore, they need no further explanation.

According to a preferred embodiment of the invention, it is provided that the application of ultrasound to the slag granular material preferably takes place simultaneously with at least two different frequencies, and that one frequency lies in the lower frequency range between 20 kHz and 35 kHz and the other frequency lies in the upper frequency range between 35 kHz and 50 kHz. This can achieve an effective triggering of the salts from the pores and fissured surfaces of the granules.

The invention also relates to a device for removing salt deposits on slag granular material, which device has a liquid container which can be acted upon by ultrasound. It is proposed that the device has a treatment basket, which can be filled with the slag granular material and immersed in the liquid container. It is provided according to a preferred embodiment of the invention that the immersed treatment basket is movable in the liquid container. As a result, a uniform application of the granular material with the ultrasonic waves is achieved even with larger fills.

It can be provided that the container has a cylindrical disc shape with a regular polygonal or circular cross section, and that the width of the disc is smaller than 300 mm and in particular smaller than 150 mm. The oscillating systems for generating the ultrasound are then aligned with the respective flat sides of the treatment basket, so that only a relatively thin layer of granules must be penetrated. As a result, grains lying on the inside are also reliably exposed to ultrasound.

Preferably, the center axis of the container is horizontal. The immersed treatment basket is also rotatable about the center axis. As a result, a thorough mixing and thus uniform application of ultrasound to the granular material is achieved.

It can be provided that the liquid container is provided with at least one plate-shaped immersible transducer, and that the emission surface of the immersible transducer is at least approximately the same size as the surface of the immersed treatment basket facing it. The immersible transducers are located on a side wall of the liquid container and are aligned with the flat side of the treatment basket immersed edgewise in the liquid bath. At least the flat sides of the treatment basket are formed as a sieve with a perforation which is smaller than the grain size of the granular material to be treated. This ensures that, on the one hand, the ultrasonic waves can act effectively on the granular material and, on the other hand, that the liquid surrounds the granules well and the granules are held securely in the treatment basket.

It is particularly expedient if two plate-shaped immersible transducers are arranged in the liquid container on a side facing the treatment basket whose emission surfaces are at least approximately the same size as the surface of the immersed container facing them. As a result, the granular material is acted upon in a disk-shaped treatment basket immersed edgewise, with two oscillating systems which act from the one flat side on the granular material.

Furthermore, it is provided according to an advantageous embodiment of the invention that in the liquid container on opposite sides in each case at least one plate-shaped immersible transducer is arranged in such a way that the treatment basket is in the immersed position between the radiating surfaces of the immersible transducer. Again, it is advantageous if two immersible transducers are arranged on the opposite sides of the liquid container.

It is also advantageous if the immersible transducers work with at least two different frequencies. It can be provided that the immersible transducer arranged on one side of the liquid container and the adjacent immersible transducer oscillator operate at different frequencies. In addition, it can be provided that the immersible transducers directly opposite one another operate at different frequencies. This ensures that the granular material is subjected to different frequencies from both sides. After half a revolution of the treatment basket about its horizontal center axis, the granular material has therefore been completely charged from both sides with different frequencies.

Furthermore, it can be provided that the liquid container is heatable. The liquid is preferably filled in the liquid container already heated, so that the heater of the liquid container only has to maintain the temperature. Already at a liquid temperature of about 40° C., an improvement of the ultrasonic effect and thus an improved detachment of the salts from the granules is affected.

It can also be provided that the rotational speed and/or the direction of rotation of the treatment basket in the immersed position is adjustable. Also, an interval operation is possible. Thus, the apparatus and the method can be easily adapted to the slag to be treated. Also, by changing these parameters, the dwell time and the temperature, the effectiveness of the treatment of the slag granular material can be optimized continuously.

It is obvious that by treating the MSWI slag granular material with ultrasound, not only the salts but also other pollutants can be released from the surfaces of the slag grains, thus producing a granular material which can be used without hesitation. The liquid in the liquid container will accumulate during the treatment with the leaked and washed off salts and pollutants. The liquid must therefore be replaced and treated from time to time. The time to change the liquid can be determined by monitoring the pH, which changes over time. The device is equipped for this purpose with a pH value transmitter, so that this time can be detected and the changing of the liquid can be displayed and performed.

The invention will be explained in more detail below with reference to the schematic drawing. The following figures are illustrative:

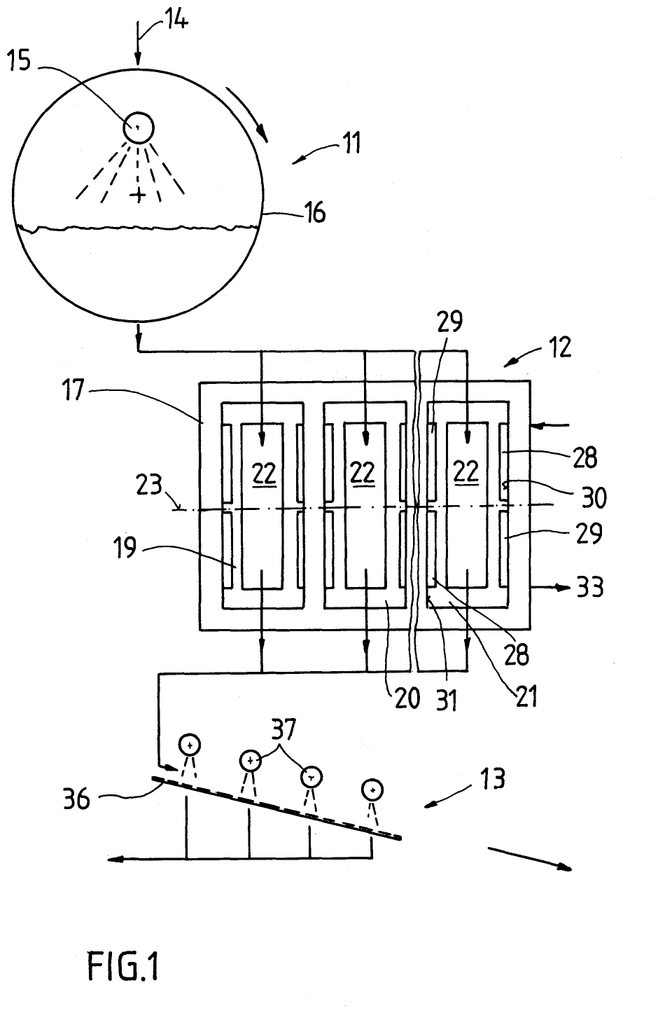

FIG. 1 shows the method scheme according to the invention,

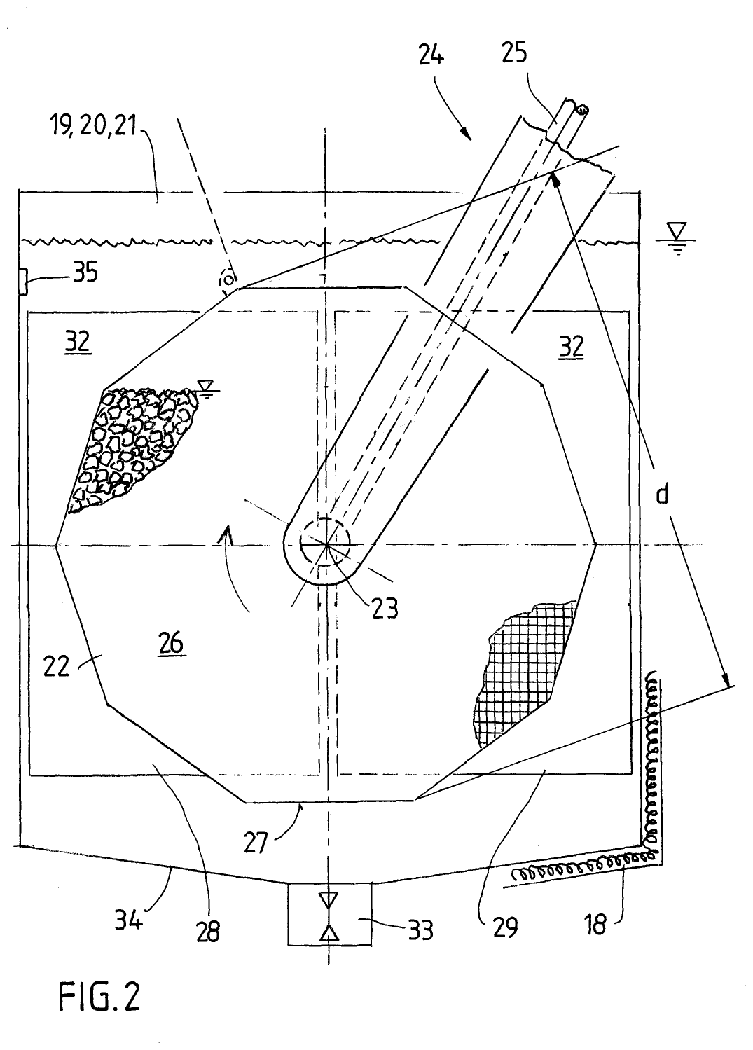

FIG. 2 shows the cross-section of the device according to the invention and

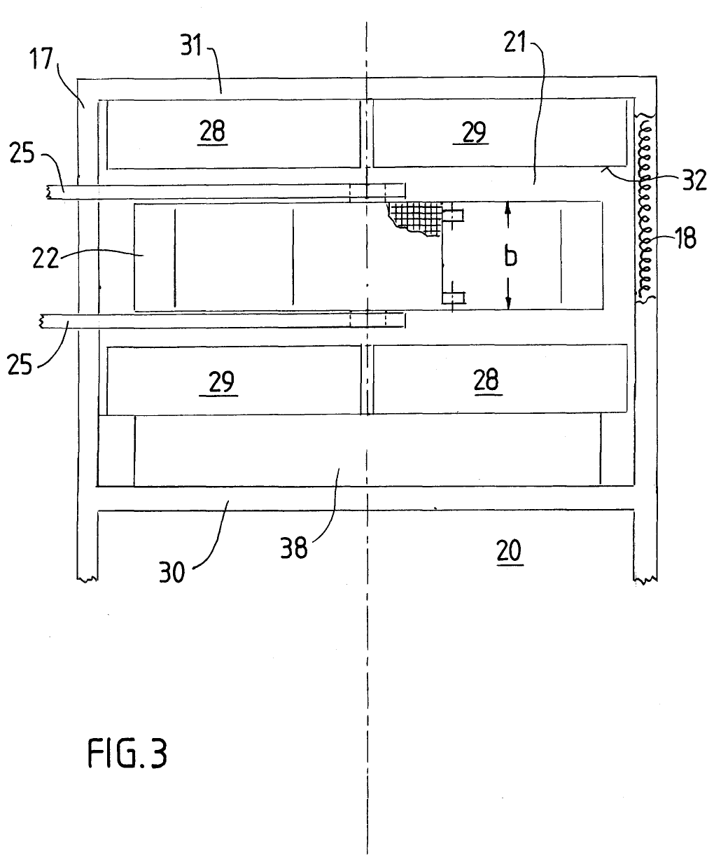

FIG. 3 shows the plan view of the device according to FIG. 1.

The three-stage system for washing/cleaning slag granular material shown in FIG. 1 comprises a pre-scrubber 11 as a first stage, a device 12 for applying ultrasound to pre-cleaned slag granular material as the second stage, and a post-scrubber 13 as the third stage. The crushed slag granular material pass via a feed 14 into the pre-scrubber 11, which is designed as a drum scrubber in the exemplary embodiment shown. The pre-scrubber 11 may also be designed as a log washer or as another scrubber, through which light and foreign substances such as wood, plastic or adhesive grains can be removed and stripped from the mixture of granular material. The drum scrubber comprises a spray bar 15 with which the granular material contained in the drum 16 is cleaned with water while the drum rotates 16. A drum washer is known and therefore needs no further explanation.

The crushed MSWI slag granular material fed to the pre-scrubber 11 has a grain size of >0.5 mm and preferably a grain size from 1 mm to 32 mm. However, they are treated as monocharges from 1 mm to 5 mm, from 5 mm to 18 mm and from 18 mm to 32 mm. But other grains sizes can also be used. The slag granular material prewashed in this way is drawn off and reaches the second stage with the ultrasonic device 12.

The ultrasonic device 12 comprises a liquid tank 17, which is filled with a liquid and in particular with water. Preferably, the liquid tank 17 or the liquid bath is heatable by the indicated heating elements 18 to keep the water at an elevated temperature of, for example, 35° C. to 50° C., or to heat it.

The liquid tank 17 is subdivided into a plurality of liquid containers 19, 20, 21, which can be fluidically connected to one another and are designed as a chamber open at the top. A treatment basket 22 is held immersed in each liquid container 19, 20, 21. The treatment baskets 22 are filled with the pre-cleaned slag granular material and then lowered into their respective associated liquid container 19, 20, 21. The treatment baskets 22 are preferably not completely but only partially filled, for example, 75% to 90% full.

In detail, the arrangement is such that the treatment basket 22 has the shape of a rotationally symmetrical cylinder. The width b of the treatment basket 22 is smaller than its diameter d, so that the treatment basket has a disc-shaped shape which is rotationally symmetrical to the central axis 23. The treatment basket 22 is rotatably mounted about this center axis 23 on a lifting mechanism 24. The center axis 23 extends horizontally, so that the container 22 is immersed upright in the liquid container 19, 20, 21.

The lifting mechanism 24 shown only schematically comprises a holding arm 25, at the free end of which the central axis 23 is arranged. The holding arm 25 is movable upwardly and downwardly and pivotally mounted on a machine frame, not shown, so that the treatment basket 22 can be moved with the holding arm 25 from its associated liquid container 19, 20, 21 lifted and moved laterally next to the liquid container on the right or left longitudinal side of the liquid tank 17 in the FIG. 2. In the exemplary embodiment shown in the drawing, a treatment basket 22 is rotatably held between two support arms 25. However, due to the relatively low weight of the filled treatment basket and the relatively low rotational speed, one-sided storage may also be sufficient.

In this non-operative position, the treatment basket 22 can be filled and emptied by a closable opening (not shown) on the peripheral side. The filling mechanisms are known per se and may include hoppers through which a predetermined amount of the slag granular material is filled into the treatment basket 22. By rotating the container 22 by 180° about its central axis 23, the purified slag granular material can be removed from the treatment basket 22 again. There may be a conveyor belt or a conveyor chute below the treatment basket 22 in its inoperative position, which collects and/or transfers the MSWI slag granular material falling out and feeds it to the third stage.

The illustrated exemplary embodiment shows a cylindrical treatment basket 22 with the-cross section of a regular decagon. But other polygons can also be chosen. A polygonal design has the advantage that the slag granular material contained in the container 22 moves in a jerky manner when rotating about the center axis 23, so that good mixing is affected. This is further also favored by the incomplete filling of the treatment basket 22.

The treatment basket 22 filled with the pre-cleaned slag granular material is immersed in the liquid container 19, 20, 21 by the lifting mechanism 24. It may be completely or partially immersed. Preferably, however, the immersion depth is selected such that the liquid level is above the level of the treatment basket 22.

At least the side surfaces 26 of the treatment basket are formed as a sieve, so that the liquid in the liquid container 19, 20, 21 can enter into the container 22 and flow around the granular material. Furthermore, the granular material is accessible from the flat sides for the ultrasonic waves. The mesh size of the sieve is smaller than the smallest grain of the granular material and is for example 0.7 mm for the treatment of a grain size of ⅕ mm, 4 mm for a grain size of 5/18 mm and 15 mm for the grain size of 18/32 mm. The peripheral walls 27 of the treatment basket 22 may also be formed as a sieve.

In each liquid container 19, 20, 21, four plate-shaped immersible transducers 28, 29 are arranged on the opposite sides 30, 31 of a liquid container, which face the side surfaces 26 of the treatment basket 22 in the exemplary embodiment shown. The radiating surfaces 32 of the immersible transducers 28, 29 on a wall 30, 31 are, in total, about the same size as the side surface 26 of the treatment basket 22 facing them. As a result, the entire side surface 26 and thus the granular material located behind it are detected substantially directly by the generated sound waves.

The immersible transducers 28, 29 are formed in pairs, and one pair of immersible transducers 28 operates at a different frequency than the other pair of immersible transducers 29. The one pair of immersible transducers 28 may operate at a frequency of 25 kHz and the other pair of immersible transducers 29 at a frequency of 40 kHz. In this case, the arrangement is such that an immersible transducer 28, 29 is arranged on each side 30, 31. Furthermore, an immersible transducer 28 lies opposite an immersible transducer 29 on the other side 31, 30. Due to this staggered arrangement of the immersible transducers 28, 29, the entire granular material has been completely acted upon by the two frequencies after half a revolution of the treatment basket 22.

During the treatment, the treatment basket 22 is preferably rotated several times about its center axis 23 in the liquid, so that a thorough mixing of the slag granular material takes place and also so that grains on the interior side can reach outward to the flat side 26. Intermittent movements or changing directions of rotation or different speeds may also be provided to aid mixing.

Due to the small width b of the treatment basket 22 from 100 mm to 300 mm, the ultrasonic waves reach sufficiently well to the further inner layers of the granular material. Furthermore, the clear width of the liquid container 19, 20, 21 is chosen so that the radiating surfaces 32 of the immersible transducers 28, 29 are at an optimal distance, which is characterized in that the reflections of the ultrasonic waves remain low, from the flat sides 26 of the treatment basket 22, which is preferably between 100 mm and 150 mm. In FIG. 3 of the drawing, a flexible arrangement of the immersible transducers 28, 28 is shown. Between the backs of the immersible transducers and the facing side 30, one or more spacers 38 are provided in order to be able to change the distance between the treatment basket 22 and the radiating surface 32. Thus, for different grain sizes different distances for an optimized treatment may be required, which are adjustable by the spacers 38 with constant dimensions of the liquid container 19, 20, 21. Preferably, the spacers 38 are located on both opposite side walls 30, 31 of the liquid container, so that the treatment basket 22 is located centrally between the radiating surfaces 32.

As a result, the ultrasonic waves can optimally penetrate the granular material in the liquid. This is easily possible with the available immersible transducers of a high power from 1,000 W to 2,000 W. The diameter of the treatment basket 22 is, for example, 600 mm to 700 mm. Overall, a safe application on all granules of ultrasound of different frequencies is achieved by these measures. The salts adhering to the surfaces of the MSWI grains salts are thereby safely and effectively expelled and dissolve in the liquid.

By mixing the granular material by rotating or shaking the treatment basket 22 about its center axis 23 in the liquid container 19, 20, 21, the individual grains are also rotated in themselves, so that their entire surface is exposed to the ultrasonic waves in their fissured and open-pored state. As a result, the salt deposits are expelled well from the samples.

In the course of several treatments of successively batch-filled treatment baskets 22, the liquid in the liquid containers 19, 20, 21 will accumulate with the expelled salts, so that the liquid must be changed. For this purpose, an outlet valve 33 in the bottom 34 of the liquid tank 17 is provided. The concentration of salts in the liquid can be determined by the pH detected by a pH sensor 35. The enriched wastewater is drawn off and can be treated.

After the treatment of a batch of slag granular material with ultrasound for a period of 30 seconds to 180 seconds, preferably between 60 seconds and 120 seconds, the treatment basket 22 is lifted out of the liquid and emptied next to the liquid tank 17, then refilled and immersed back in the liquid. This can be automated and takes about 10 seconds to 20 seconds, so that it takes about 40 seconds to 200 seconds to treat a batch.

For a treatment basket 22 having a width of b=150 mm and a diameter of d=650 mm, a filling degree of 85% and an assumed density of the slag granular material of ρ=1,200 kg/m³, a batch has a weight of about 47.43 kg. Assuming a cycle time of 140 sec, the throughput per treatment basket is about 1.22 Mg/h. With four treatment baskets, the total throughput is thus 4.89 Mg/h. This allows larger quantities to be treated and cleaned sufficiently quickly.

The slag granular material largely freed of salt deposits in this manner is then fed to the aftertreatment. The post-scrubber 13 has an oblique vibratory drip/dewatering screen 36 on which the slag granular material is conveyed. It is acted upon by nozzle strips 37 with clean water, so that the salts adhering to the surface of the granular material can be dissolved and removed. The water with the dissolved salts is collected and can be supplied, for example, to the drum washer 11 of the first stage as washing water.

With this three-stage method, effective cleaning of slag granular material can be carried out, for example, from municipal solid waste incineration plants. A sample of slag granular material from a municipal solid waste incineration plant was tested for sulfate and chloride content. After the pre-cleaning in the first stage, the chloride content was 129 mg/l and the sulfate content was 320 mg/l in the eluate. After the treatment in the second stage with ultrasound, the chloride content was only 36 mg/l and the sulphate content 96 mg/l in the eluate. After the treatment in the third stage, the chloride content was 27 mg/l and the sulfate content 94 mg/l in the eluate. It was therefore possible to comply with the limit values for the classification value Z1.2 of the TR-LAGA soil from November 2003 for the granular material cleaned/washed with the three-stage method.

Due to the possibility of arranging many treatment baskets 22 side by side in a liquid tank 17, a large amount of slag granular material can be quickly cleaned and provided as building material with the classification number Z1.2. The starting material can be cheaply procured, since it would otherwise have to be disposed of in a cost-intensive manner, in order for investment costs to be amortized well.

Due to the low pollutant content, the purified slag granular material is also suitable for a landfill class DK0 of the Landfill Ordinance [German: Deponie-Verordnung], so that cost-effective landfilling is also possible.

FIG. 1 shows a diagram with only one line. Of course, it is also possible that several lines are present next to each other. It is expedient that, in the case of several lines, first of all a common pre-wash of all particle sizes in the first stage takes place. Subsequently, the granular material is classified, for example, in three particle sizes ⅕ mm, 5/18 mm and 18/32 mm. These classes are then further treated in respective treatment baskets 22 of corresponding mesh size in the second and finally in the third stage.

1. A method for washing/cleaning granulate material from slag and bottom and boiler ash from thermal waste treatment, wherein the slag granular material is introduced into a liquid bath (17) which is subjected to ultrasound, and in that the slag granular material is moved in the liquid bath (17).

2. The method according to claim 1, wherein the slag granular material is circulated in the liquid bath at least once.

3. The method according to claim 1, wherein the slag granular material is introduced into a treatment basket (22) which is immersed in the liquid bath (17) and the treatment basket (22) moves in the liquid bath (17).

4. The method according to claim 3, wherein the treatment basket (22) is filled discontinuously with the slag granular material and emptied again.

5. The method according to claim 1, wherein the slag granular material is pre-cleaned prior to the application of ultrasound to remove suspended matter, light materials and adhesive grains.

6. The method according to claim 1, wherein the slag granular material is cleaned after the application of ultrasound to remove the expelled or dissolved salts from the slag granular material.

7. The method according to claim 1, wherein the liquid bath (17) contains a heated liquid and/or is heatable.

8. The method according to claim 1, wherein ultrasound is applied at a frequency of 20 kHz to 50 kHz.

9. The method according to claim 1, wherein ultrasound is applied at at least two different frequencies, and that the one frequency in the lower frequency range lies between 20 kHz and 35 kHz and the other frequency lies in the upper frequency range between 35 kHz and 50 kHz.

10. The method according to claim 9, wherein the application of ultrasound with different frequencies takes place simultaneously.

11. A device for removing salt deposits from slag granular material, which device has at least one liquid container (19, 20, 21) which can be acted upon by ultrasound, wherein the device has at least one treatment basket (22) which can be filled with the slag granular material and is immersible into the liquid container (19, 20, 21).

12. The device according to claim 11, wherein the immersed treatment basket (22) is movable in the liquid container (19, 20, 21).

13. The device according to claim 11, wherein the treatment basket (22) has a cylindrical disc shape with a polygonal or circular cross-section, and that the width (b) of the disc is less than 300 mm and in particular less than 150 mm.

14. The device according to claim 13, wherein the center axis (23) of the treatment basket (22) extends horizontally.

15. The device according to claim 14, wherein the immersed treatment basket (22) is rotatable about its central axis (23).

16. The device according to claim 11, wherein the liquid container (19, 20, 21) is provided with at least one plate-shaped immersible transducer (28, 29), and that the emission surface (32) of the immersible transducer (28, 29) is at least approximately the same size as the surface (26) of the immersed treatment basket facing it (22).

17. The device according to claim 16, wherein in the liquid container (19, 20, 21) on a side facing the container (22) (30, 31) two plate-shaped immersible transducers (28, 29) are arranged, whose radiating surfaces (32) are at least approximately the same size as the surface (26) of the immersed treatment basket (22) facing them.

18. The device according to claim 17, wherein in the liquid container (19, 20, 21) on opposite sides (30, 31), in each case at least one plate-shaped immersible transducer (28, 29) is arranged such that the treatment basket (22) in the immersed position is located between the radiating surfaces (32) of the immersible transducers (28, 29).

19. The device according to claim 16, wherein between the immersible transducers (28, 29) and the sides facing them (30, 31) of the liquid container (19, 20, 21), at least one spacer (38) is mountable to the distance between the radiating surfaces (32) and the surface (26) of the treatment basket (22) facing them.

20. The device according to claim 19, wherein on the opposite sides (30, 31) of the liquid container (19, 20, 21), in each case two immersible transducers (28, 29) are arranged.

21. The device according to claim 16, wherein the immersible transducers (28, 29) operate with at least two different frequencies.

22. The device according to claim 16, wherein the immersible transducers arranged on one side (30, 31) of the liquid container (19, 20, 21) and the adjacent immersible transducers (28, 29) operate at different frequencies.

23. The device according to claim 17, wherein the directly opposite immersible transducers (28, 29) operate at different frequencies.

24. The device according to claim 11, wherein the liquid container (19, 20, 21) is heatable.

25. The device according to claim 12, wherein the rotational speed and/or the direction of rotation of the treatment basket (22) is adjustable at least in the immersed position.
